(19) United States
(12) Patent Application Publication
(10) Pub. No.: US 2016/0074946 A1
(43) Pub. Date: Mar. 17, 2016

(54) MULTI-AXIS MACHINING SYSTEMS AND RELATED METHODS

(71) Applicant: Pocket NC Company, Bozeman, MT (US)

(72) Inventors: Matthew Hertel, Bozeman, MT (US); Michelle Hertel, Bozeman, MT (US)

(21) Appl. No.: 14/998,005

(22) Filed: Sep. 12, 2014

(51) Int. Cl. B23C 1/025; B23Q 5/32; B23Q 5/40; B23C 1/14

(52) U.S. Cl. CPC B23C 1/025; B23C 1/14; B23Q 5/326; B23Q 5/40

(57) ABSTRACT

Embodiments disclosed herein relate to a multi-axis machining system (e.g., a milling machine) that may have multiple moveable and/or rotatable axes. For instance, the multi-axis machining system may be computer numerically controlled (CNC), such that a controller may activate or control movement along and/or rotation about the axes of the multi-axis machining system.

### BACKGROUND

Generally, various machines may be used to remove material in a manner that produces a machined part. Milling machines, for example, may use cutting tools that typically rotate with a spindle and remove material during engagement of the cutting tool with a stock block. For instance, a typical milling machine may use end mills, drills, taps, boring bars, etc., to engage and cut or remove material from the stock block. In some instances, reducing the size and/or footprint of the milling machine may facilitate installation and operation thereof at various locations (e.g., a desktop milling machine may be set up on a desk, while a typical milling machine requires shop floor space), reduced manufacturing costs, etc. Moreover, milling machines that facilitate machining the stock block on multiple sides and/or at more than one angle may reduce the number of setups for producing some parts.

Accordingly, users and manufacturers of multi-axis machining systems, such as milling machines, continue to seek improvements to portability and versatility thereof.

### SUMMARY

Embodiments disclosed herein relate to a multi-axis machining system (e.g., a milling machine) that may have multiple moveable and/or rotatable axes. For instance, the multi-axis machining system may be computer numerically controlled (CNC), such that a controller may activate or control movement along and/or rotation about the axes of the multi-axis machining system. In some embodiments, the multi-axis machining system may produce linear movement along three axes. Additionally or alternatively, the multi-axis machining system may produce rotational or pivoting movement about two rotation axes. Accordingly, the multi-axis machining system may machine a stock block by removing material therefrom on multiple sides and/or at multiple angles.

At least some embodiments involve a multi-axis machining system that includes a first rotary table and a second rotary table. The first rotary table includes a work surface rotatable about an B-axis relative to an approximately horizontal support surface. The second rotary table includes a mounting surface rotatable about a A-axis relative to the horizontal support surface. Also, the second rotary table is linearly moveable along a Y-axis that is approximately perpendicular to the horizontal surface. The first rotary table is secured to the mounting surface of the second rotary table. The multi-axis machining system also includes a spindle head securing a spindle. The spindle head is linearly moveable along a Z-axis relative to the horizontal support surface and toward and away from the work surface of the first rotary table, the Z-axis being approximately perpendicular to the Y axis and approximately parallel to the horizontal surface.

Embodiments also include a multi-axis machining system that includes a machine base positionable on an approximately horizontal support surface. Such a multi-axis machining system also includes a carriage movably connected to the machine base and linearly movable relative to the machine base along an X-axis. The multi-axis machining system further includes a spindle head movably connected to the carriage and linearly moveable relative to the carriage along a Z-axis that is approximately perpendicular to the X-axis, the X-axis and the Z-axis defining an imaginary plane that is approximately parallel to the horizontal support surface. The multi-axis machining system also includes a first rotary table that has a mounting surface rotatable about a A-axis relative to the horizontal support surface. The A-axis is approximately parallel to the X-axis, and the second rotary table is linearly moveable along a Y-axis that is approximately perpendicular to the horizontal surface. Additionally, the multi-axis machining system includes a second rotary table secured to the mounting surface of the first rotary table and including a work surface rotatable relative to the horizontal support surface about a B-axis.

One or more embodiments include a method of machining a stock block. In particular, for example, the method includes moving the stock block along a Y-axis that is approximately perpendicular to a horizontal plane. The method further includes pivoting the stock block about an A-axis and a B-axis. The B-axis pivots about the A-axis, and the A-axis is approximately parallel to the horizontal plane. The method also includes linearly advancing a rotating cutting tool along an X-axis that is approximately perpendicular to the Y-axis, approximately perpendicular to a rotation axis of the cutting tool, and approximately parallel to the horizontal plane. Furthermore, the method includes linearly advancing the cutting tool along a Z-axis that is approximately perpendicular to the X-axis and Y-axis and approximately parallel to the rotation axis of the cutting tool and to the horizontal plane.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments, wherein identical reference numerals refer to identical or similar elements or features in different views or embodiments shown in the drawings.

FIG. 1 is a front, isometric view of a milling machine according to an embodiment

FIG. 2 is a back, isometric view of the milling machine of FIG. 1;

FIG. 3 is a top view of the milling machine of FIG. 1;

FIG. 4 is an isometric view of rotary tables of the milling machine of FIG. 1;

FIG. 5 is a front, isometric view of a second rotary table of the rotary tables of FIG. 4;

FIG. 6 is a back, isometric view of a second rotary table of the rotary tables of FIG. 4;

FIG. 7 is a back, isometric view of a vertical support of the milling machine of FIG. 1; and

FIG. 8 is a back, isometric view of a machine base of the milling machine of FIG. 1.

### DETAILED DESCRIPTION

Embodiments disclosed herein relate to a multi-axis machining system (e.g., a milling machine) that may have multiple moveable and/or rotatable axes. For instance, the multi-axis machining system may be computer numerically controlled (CNC), such that a controller may activate or control movement along and/or rotation about the axes of the multi-axis machining system. In some embodiments, the multi-axis machining system may produce linear movement along three axes. Additionally or alternatively, the multi-axis machining system may produce rotational or pivoting movement about two rotation axes. Accordingly, the multi-axis machining system may machine a stock block by removing material therefrom on multiple sides and/or at multiple angles.

In an embodiment, the multi-axis machining system may move the stock block along one or more linear axes. For example, a cutting tool (e.g., and end mill) may be engaged with at least a portion of the stock block, while the multi-axis machining system linearly advances the stock block along one or more axes (e.g., along X-axis, Y-axis, Z-axis, or combinations thereof). Moreover, the multi-axis machining system may include a spindle that may secure and rotate the cutting tool. For instance, the spindle may rotate the cutting tool during engagement of the cutting tool with the stock block and/or during linear advancement of the stock block.

In at least one embodiment, the cutting tool may be advanced toward and/or into the stock block. For example, the multi-axis machining system may linearly advance the spindle together with the cutting tool toward the stock block, while rotating the cutting tool in the spindle. Specific cutting tools may vary from one embodiment to the next. For instance, suitable cutting tools include end mills, shell mills, thread mills, taps, drills, boring bars, etc. In any case, the cutting tool may cut or remove material from the stock block, thereby machining the stock block.

As mentioned above, in some embodiments, the multi-axis machining system may include pivot or rotation axes. For example, the stock block may be pivoted and/or rotated about one or more rotation axes. In at least one embodiment, such rotation axes may be oriented perpendicularly to each other. Alternatively, rotation axes may be oriented at any suitable angle relative to each other, which, in some instances, may be adjusted and/or changed. As such, for instance, the stock block may be pivoted or rotated in one or more planes that may be non-perpendicular to the linear axes of the milling machine (e.g., by pivoting or rotating the stock block about the two rotation axes simultaneously and/or sequentially).

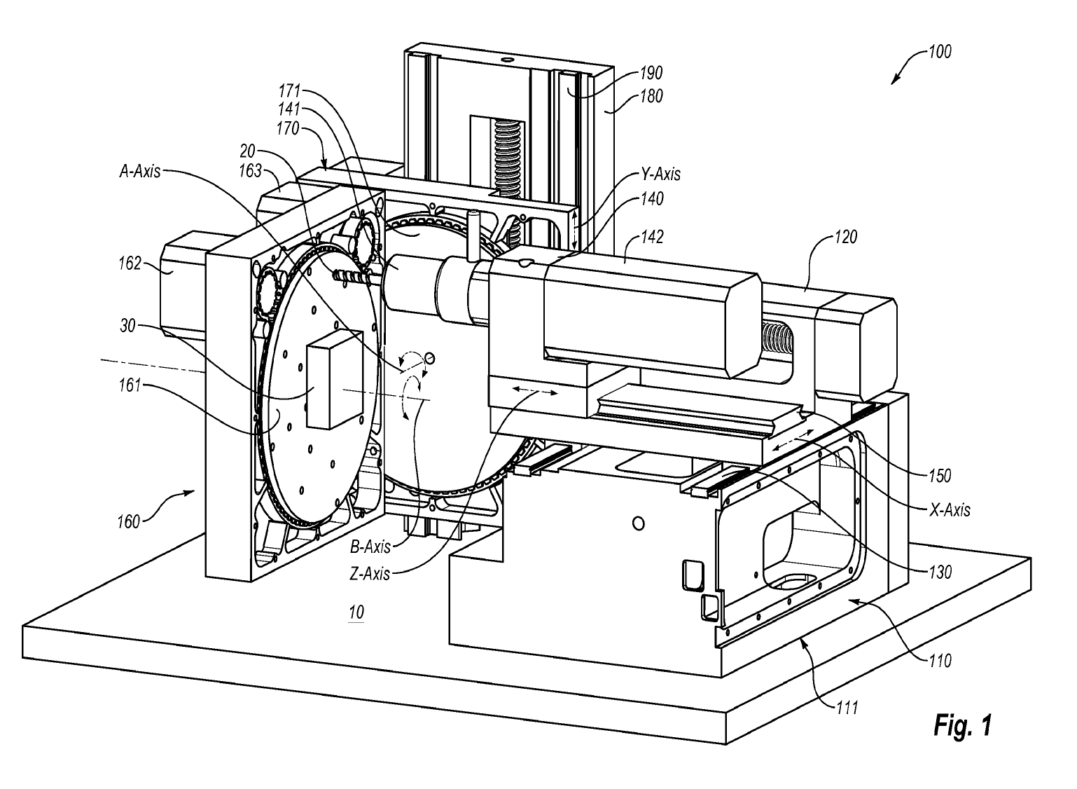

FIGS. 1-3 illustrate a multi-axis machining system 100 according to an embodiment. For example, as shown in FIG. 1, the multi-axis machining system 100 includes a machine base 110 and a carriage 120 slidably mounted to the machine base 110. Generally, the machine base 110 may have one or more supports or a platform that may be set on a horizontal support surface 10 (e.g., table, floor, etc.). In an embodiment, the machine base 110 includes a platform surface 111 that may be set on the horizontal support surface 10 (e.g., the platform surface 111 may orient the machine base 110 relative to the horizontal support surface 10. In some examples, the machine base 110 may include one or more adjustable supports or feet, which may be adjusted to level the machine base 110. In any event, the machine base 110 may be positioned on the horizontal support surface 10 in a suitable manner and in a suitable orientation. Furthermore, in some instances, the machine base 110 may be fastened, clamped, or otherwise secured to the horizontal support surface 10.

The base 110 may include any suitable material or combinations thereof. For example, the base 110 may be manufactured from an aluminum, steel, cast iron, etc. In some instances, the base 110 may be manufactured from plastic (e.g., reinforced plastics), fiberglass, carbon fiber material, etc. In any event, the base 110 may be manufactured from any suitable material that may provide sufficient rigidity and dimensional stability suitable for a desired precision of the multi-axis machining system 100. The carriage 120 as well as other elements and/or components of the multi-axis machining system 100 may include and/or may be manufactured from a similar or the same material as the base 110, as may be suitable for a particular configuration of the multi-axis machining system 100.

In some embodiments, the multi-axis machining system 100 includes one or more linear machine ways, such as guide rails 130, which may be secured to the machine base 110. A pillow block may be slidably connected to the guide rails 130 and may be fixedly connected to the carriage 120. Hence, the carriage 120 is moveable together with the pillow block along the guide rails 130 along an X-axis, as shown with the arrows in FIG. 1.

As described below in more detail, the carriage 120 may be linearly advanced along the X-axis in a first direction and/or in a second, opposite direction relative to the machine base 110 and/or relative to the stock block. In addition, in at least one embodiment, the multi-axis machining system 100 includes a spindle head 140 that moves linearly along a Z-axis. The spindle head 140 may move in a first direction (e.g., toward the stock block) or in a second, opposite direction (e.g., away from the stock block). In some instances, the Z-axis is perpendicular to the X axis. Particular attachment or configuration of the spindle head 140 may vary from one embodiment to the next. In an embodiment, the spindle head 140 may slide or move linearly along at least one linear machine way on the carriage 120 (e.g., along spindle 141).

Generally, the carriage 120 includes one or more machine ways that slidably secure the spindle head 140 to the carriage 120, such that the spindle head 140 may move linearly along the Z-axis of the multi-axis machining system 100. For example, a guide rail 150 may be mounted to and/or incorporated with the carriage 120 and may be approximately parallel to the Z-axis of the multi-axis machining system 100. The spindle head 140 may include one or more pillow blocks that may slidably engage the guide rail 150, such that the spindle head 140 may move linearly along the guide rail 150 in a positive and/or in a negative direction as shown with the arrows. It should be appreciated that, as mentioned above, the machine ways securing the spindle head 140 to the carriage 120 may vary from one embodiment to another (e.g., box ways may be incorporated into the carriage 120 and the spindle head 140 may be secured to the box ways by corresponding pillow block(s)).

According to at least one embodiment, the spindle head 140 includes a spindle 141 secured thereto. Generally, the multi-axis machining system 100 may include any suitable spindle 141, which includes a rotatable portion that may secure a cutting tool (e.g., cutting tool 20). More specifically, for instance, rotation of the rotating portion of the spindle 141 may produce a corresponding rotation of the cutting tool 20. As mentioned above, as the cutting tool 20 rotates while engaged with the stock block 30, the cutting tool 20 may remove material from the stock block 30. Hence, the spindle 141 may provide sufficient or suitable rigidity to and clamping of the cutting tool 20 to produce a desired or suitable cut or otherwise remove material from the stock block 30.

For example, the spindle 141 may be a commercially available spindle, such as a collet chuck, lever type spindle NRR 2651, which is available from NSK NAKSNISHI, and which includes a quick tool release mechanism for securing and/or releasing a cutting tool 20. In any event, the spindle 141 may rotatably secure a cutting tool 20 therein, such that the cutting tool 20 may engage and cut the stock block. For instance, a cutting tool holder (e.g., a collet, chuck, etc.) may be connected to or integrated with the spindle 141 and may secure the cutting tool 20 that may have a standard or a non-standard size or diameter.

In an embodiment, the spindle head 140 includes a spindle motor 142 operably connected to the spindle 141, such that rotation of the motor produces corresponding rotation of the cutting tool secured in the spindle 141. The multi-axis machining system 100 may include any suitable spindle motor, which may vary from one embodiment to the next. In some embodiments, the spindle motor 142 may have variable speed between 65 RPM and 10,000 RPM. Moreover, as described below in more detail, a controller may regulate the speed of rotation of the spindle motor 142 and, thereby, of the cutting tool.

Hence, as the carriage 120 and spindle head 140 move relative to the machine base 110, the cutting tool 20 moves relative to a stock block 30 and may remove material therefrom. The stock block 30 may have any suitable shape and/or size, which may vary from one embodiment to the next (e.g., the stock block 30 may include at least one substantially planar side or surface). Additionally or alternatively, the stock part may move relative to the cutting tool 20. In some embodiments, the cutting tool 20 may be mounted or secured to a portion of the multi-axis machining system 100 that is moveable relative to the machine base 110. For example, the multi-axis machining system 100 may include a rotatable work surface 161 (e.g., the rotatable work surface 161 may have a planar surface, which may be approximately perpendicular to the spindle 141 and/or to the Z-axis of the multi-axis machining system 100).

Generally, the work surface 161 may include any number of suitable features or elements that may facilitate securing of the stock block 30 thereto. In one embodiment, the work surface 161 includes threaded holes (e.g., the stock block 30 may be secured to the work surface 161 with one or more clamps that may be fastened in the threaded holes of the work surface 161). It should be appreciated, however, that the work surface 161 may include additional or alternative features and/or devices for securing the stock block 30 thereto, such as vise(s), angle plate(s), chuck(s), etc.

More specifically, the work surface 161 may be rotatable about a B-axis. In at least one embodiment, the B-axis is parallel to the Z-axis. In other words, the stock block 30 and cutting tool 20 may rotate above axes that are parallel to each other. In an example, the multi-axis machining system 100 may include a first rotary table 160 that includes the work surface 161. Alternatively or additionally, as described below in more detail, the work surface 161 and the B-axis may be reoriented (e.g., during operation of the multi-axis machining system 100), such that the B-axis is oriented at a non-parallel angle relative to the Z-axis.

In some examples, the stock block 30 may rotate about another rotation axis, such as about an A-axis, which may be oriented at a non-parallel angle relative to the B-axis. In an embodiment, the first rotary table 160 is connected to a second rotary table 170, which may rotate the first rotary table 160 and the work surface 161 together with the stock block 30 about the A-axis. Hence, such rotation of the first rotary table 160 and the work surface 161 about the A-axis may reorient the B-axis relative to the Z-axis, as noted above.

In some instances, the A-axis is perpendicular to the B-axis (e.g., the A-axis may be parallel to the X-axis and/or perpendicular to the Z-axis of the multi-axis machining system 100). For example, the multi-axis machining system 100 may rotate the stock block 30 about the A-axis, which may be perpendicular to the axis of rotation of the cutting tool 20.

The second rotary table 170 may be similar to or the same as the first rotary table 160. For example, the second rotary table 170 may include a mounting surface 171 that is rotatable about the A-axis, and which secures the first rotary table 160 (i.e., the mounting surface may rotate together the first rotary table 160). Hence, rotation of the mounting surface 171 may produce corresponding rotation of the first rotary table 160 (and work surface 161) together with the stock block 30 about the A-axis. In some embodiments, the multi-axis machining system 100 may rotate the stock block 30 about the A-axis and about the B-axis. For example the stock block 30 may rotate about the A-axis and about the B-axis simultaneously (e.g., rotating about both A- and B-axes at the same or at different speeds) or sequentially (e.g., first rotating about the A-axis and subsequently about the B-axis, or vice versa).

Additionally or alternatively, the multi-axis machining system 100 may move the stock block 30 along a linear axis relative to the machine base 110 and/or relative to the cutting tool 20. In an embodiment, the multi-axis machining system 100 may move the stock block 30 along a Y-axis, which is perpendicular to the X-axis and Z-axis of the multi-axis machining system 100. According to one example, the multi-axis machining system 100 includes a vertical support 180 that is connected to the machine base 110 and remains stationary relative thereto. In some embodiments, the vertical support 180 may be integrated with the machine base 110 (e.g., may be manufactured from a single piece of material). In any event, the vertical support 180 may be fixedly positioned relative to the machine base 110 and relative to the horizontal support surface 10.

Furthermore, in an embodiment, the second rotary table 170 is slidably attached to the vertical support 180. More specifically, in at least one example, the multi-axis machining system 100 includes linear machine ways, such as the guide rails 190, and the second rotary table 170 may be slidably connected to the guide rails 190 (e.g., a pillow block may be slidably connected to guide rails 190 and fixedly connected to the second rotary table 170). In any event, the first and second rotary table 160, 170 together with the stock block 30 may move linearly along the Y-axis.

As such, the first and second rotary tables 160, 170 and the stock block 30 may move along the Y-axis relative to the cutting tool 20. In particular, the stock block 30 may move in a direction that is perpendicular to the rotation axis of the cutting tool 20. Moreover, as described below in more detail, the multi-axis machining system 100 may linearly move any of the carriage 120, spindle head 140, and second rotary table 170 and may rotate or pivot any of the work surface 161 and the mounting surface 171 synchronously or asynchronously to produce a desired relative positions and/or movement between the stock block 30 and cutting tool 20.

In at least one embodiment, an imaginary plane defined by the X-axis and by the Z-axis may be approximately parallel to the platform surface 111 of the base 110 and/or to the horizontal support surface 10. Also, imaginary planes defined by the X-axis and Y-axis and/or by the Z-axis and by the Y-axis may be approximately perpendicular to the platform surface 111 of the base 110 and/or to the horizontal support surface 10. Also, in some embodiments, the vertical support 180 and/or the guide rails 190 may be approximately perpendicular to the platform surface 111 of the base 110 and/or to the horizontal support surface 10.

In some embodiments, the mounting surface 171 of the second rotary table 170 is approximately perpendicular to the platform surface 111 of the base 110 and/or to the horizontal support surface 10. For instance, an imaginary plane of rotation of the mounting surface 171, which is defined by the A-axis, may be approximately perpendicular to the Y-axis. Also, in some embodiments, the vertical support 180 and/or the guide rails 190 may be approximately perpendicular to the platform surface 111 of the base 110 and/or to the horizontal support surface 10. Furthermore, in some instances, the work surface 161 may be approximately perpendicular to the platform surface 111 of the base 110 and/or to the horizontal support surface 10. As such, the A-axis and the B-axis may define an imaginary plane that may be approximately perpendicular to the platform surface 111 of the base 110 and/or to the horizontal support surface 10. Alternatively or additionally, however, the work surface 161 may be repositioned (e.g., during operation of the machine system 100) to form a non-perpendicular angle relative to the platform surface 111 of the base 110 and/or to the horizontal support surface 10. In an embodiment, the Y-axis and the B-axis may define or lie in an imaginary plane that may be perpendicular to the platform surface 111 of the base 110 and/or to the horizontal support surface 10. Similarly, in at least one embodiment, the Y-axis and the A-axis may define or lie in an imaginary plane that may be perpendicular to the platform surface 111 of the base 110 and/or to the horizontal support surface 10.

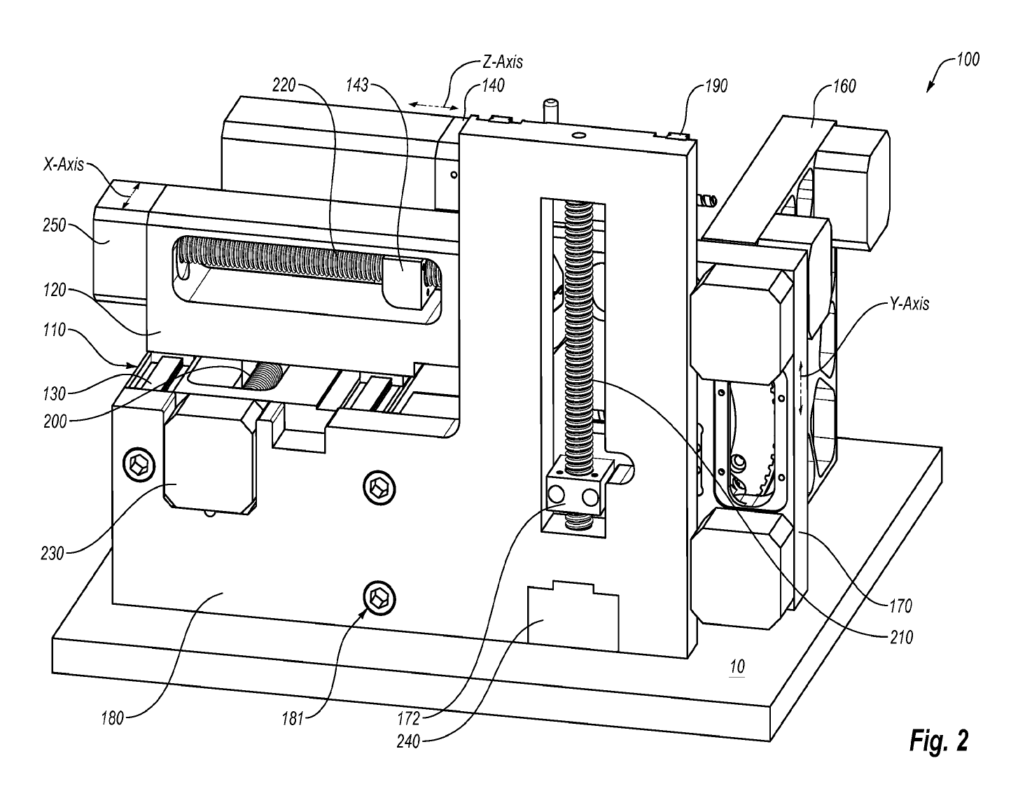

As mentioned above, the vertical support 180 may be secured to or incorporated with the machine base 110. As shown in FIG. 2, according to at least one embodiment, the vertical support 180 is generally L-shaped. It should be appreciated, however, that the vertical support 180 may have any suitable shape (e.g., rectangular, square, etc.). Also, in one example, the vertical support 180 includes multiple bolt holes 181, which may accept fasteners that may fasten the vertical support 180 to the machine base 110. In additional or alternative embodiments, the vertical support 180 may be welded, riveted, or otherwise secured to the machine base 110. Moreover, in some instances, the vertical support 180 may be fastened to or integrated with the horizontal support surface 10. In any event, according to at least one embodiment, the vertical support 180 is positioned and oriented in a manner that supports the guide rails 190 perpendicular to the guide rails 130.

Generally, the linear and/or radial movement of elements and/or components of the multi-axis machining system 100 may be produced with any number of suitable mechanisms. As shown in FIG. 2, in at least one embodiment, the multi-axis machining system 100 includes multiple screws, such as lead screws 200, 210, 220, rotation of which may produce corresponding linear movements of elements and/or components of the multi-axis machining system 100 along the respective X-axis, Y-axis, and Z-axis. It should be appreciated that embodiments also may include other suitable advancement mechanisms, such as ball screws, worm gears, etc.

More specifically, according to one embodiment, the lead screw 200 is operably connected to an X-axis stepper motor 230. Furthermore, the lead screw 200 is operably coupled to a corresponding nut, which is secured or connected to the carriage 120. Also, the lead screw 200 is rotatable secured to the machine base 110. Hence, rotation of the lead screw 200 may advance the nut thereon together with the carriage 120 along the X-axis (in a positive or in a negative direction). For example, rotation of the X-axis stepper motor 230 may rotate the lead screw 200 and advance the nut engaged therewith and the carriage 120 along the X-axis relative to the machine base 110.

In some embodiments, the X-axis stepper motor 230 includes an encoder. Alternatively or additionally, an encoder may be connected to the lead screw 200. Moreover, in at least one embodiment, the multi-axis machining system 100 may include one or more linear encoders that may directly obtain or sense linear displacement or movement of the carriage 120 along the X-axis. In any event, signal from the encoder, which may represent angle of rotation of the lead screw 200, may be sent to the controller. Also, the X-axis stepper motor 230 may be connected to the controller, which may power and/or operate the X-axis stepper motor 230, thereby rotating the lead screw 200 and advancing the carriage 120 relative to the machine base 110 along the X-axis to a suitable or preset location and/or at a suitable or preset speed. Such advancement of the carriage 120 along the X-axis may produce relative movement between the cutting tool in the stock block, thereby removing material from the stock block.

Similarly, in an embodiment, the lead screw 210 is operably connected to a Y-axis stepper motor 240. Furthermore, in some instances, the lead screw 210 is operably coupled to a corresponding nut 172, which is secured or connected to the second rotary table 170. Moreover, in at least one example, the lead screw 210 is rotatably connected to the vertical support 180. Hence, rotation of the lead screw 210 may advance the nut 172 together with the second rotary table 170 relative to the vertical support 180. For example, rotation of the Y-axis stepper motor 240 may rotate the lead screw 210 and advance the nut 172 and the second rotary table 170 along the Y-axis relative to the vertical support 180 and machine base 110.

In some embodiments, the Y-axis stepper motor 240 includes an encoder. Alternatively or additionally, an encoder may be connected to the lead screw 210. Also, as mentioned above, in at least one embodiment, the multi-axis machining system 100 may include linear encoder(s) that may directly obtain or sense linear displacement or movement of the second rotary table 170 along the Y-axis. In any event, signal from the encoder, which may represent angle of rotation of the lead screw 210, may be sent to the controller. Also, the Y-axis stepper motor 240 may be connected to the controller, which may power and/or operate the Y-axis stepper motor 240, thereby advancing the second rotary table 170 along the Y-axis, relative to the vertical support 180 and machine base 110, to a suitable or preset location and/or at a suitable or preset speed. As described above, advancement of the second rotary table 170 along the Y-axis may produce corresponding advancement of the first rotary table 160 and of the stock block attached thereto along the Y-axis relative to the cutting tool, thereby removing material from the stock block as the cutting tool rotates and engages the stock block during advancement thereof.

As mentioned above, the machine base 110 may have a platform surface that may support the multi-axis machining system 100 on the support surface 10 and may provide relative orientation thereof. In some embodiments, the multi-axis machining system 100 may include one or more feet (e.g., flexible or rubber feet) that may support the multi-axis machining system 100 on the support surface. Furthermore, the feet may separate the machine base 110 and/or vertical support 180 from the support surface 10 or provide clearance therebetween. In some examples, the feet may be adjustable (e.g., adjustment of the feet may level the multi-axis machining system 100 such that one or more portions of the machine base 110 and/or of the vertical support 180 are parallel to the support surface 10). In some instances, the multi-axis machining system 100 may be leveled such that the imaginary plane formed by the X-axis and the Z-axis thereof is approximately parallel to a horizontal plane defined by the gravitation vector (i.e., a horizontal plane that is perpendicular to the gravity vector).

In an embodiment, the lead screw 220 is operably connected to a Z-axis stepper motor 250. Furthermore, the lead screw 220 is operably coupled to a corresponding nut 143, which is secured or connected to the spindle head 140. Hence, rotation of the lead screw 220 may advance the nut 143 thereon together with the spindle head 140. For example, rotation of the Z-axis stepper motor 250 may rotate the lead screw 220 and advance the nut 143 and the spindle head 140 along the Z-axis relative to the machine base 110 and relative to the vertical support 180. Such advancement of the spindle head 140 along the Z-axis may produce relative movement between the cutting tool in the stock block, thereby removing material from the stock block.

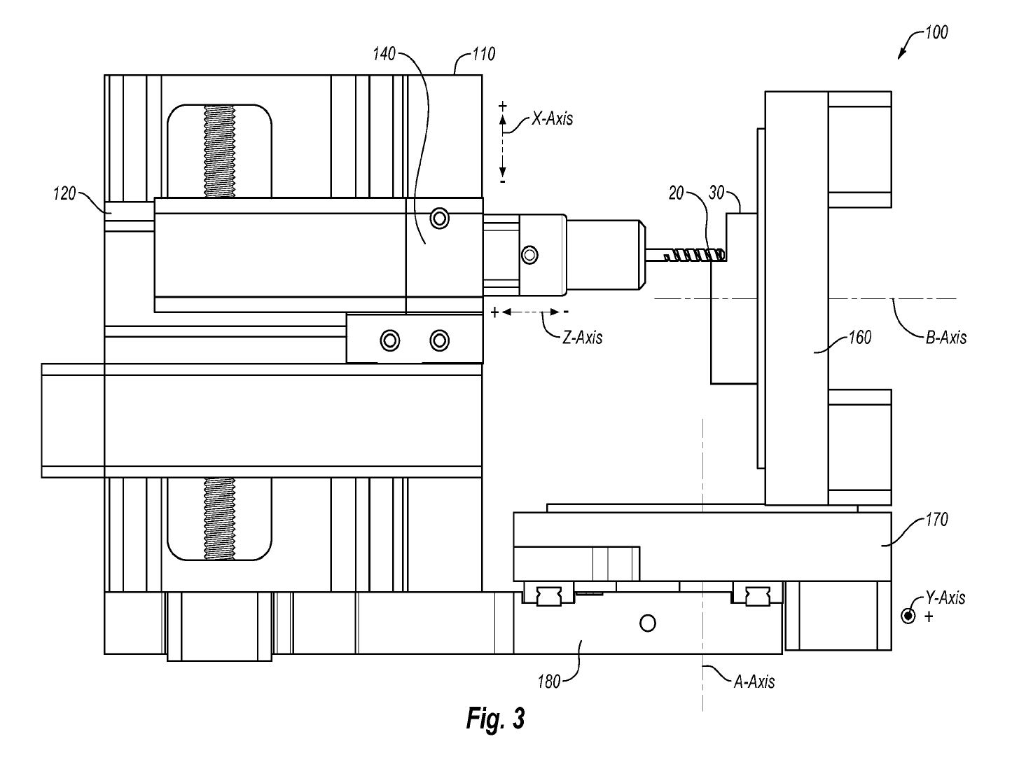

In any event, relative movement of the cutting tool and stock block may produce material removal from the stock block. For example, as shown in FIG. 3, the multi-axis machining system 100 may produce or generate relative movement between the cutting tool 20 and stock block 30 along the X-axis, Y-axis, or Z-axis and/or about A-axis or B-axis, or combinations thereof. Moreover, as described above, in some embodiments, relative movement between the cutting tool 20 and stock block 30 along the X-axis and/or Z-axis may be produced by moving the carriage 120 and/or the spindle head 140 of the multi-axis machining system 100 relative to the machine base 110.

Furthermore, when moving along the X-axis and/or Z-axis, the cutting tool 20 may move in a horizontal plane (e.g., in a plane that is approximately parallel to a support surface supporting the machine base 110 of the multi-axis machining system 100). Additionally or alternatively, movement of the stock block 30 along the Y-axis may be approximately vertical or perpendicular to the horizontal plane defined by the X-axis and Z-axis. For instance, movement of the stock block 30 and the Y-axis may be approximately perpendicular to the support surface supporting the machine base 110 of the multi-axis machining system 100.

Also, as described above, the stock block 30 may rotate or pivot about the A-axis and/or B-axis. For instance, the multi-axis machining system 100 may include sufficient clearance between the machine base 110 and the first and second rotary tables 160, 170, which may facilitate rotation or pivoting of the first and/or second rotary tables 160, 170 and the stock block 30 about the respective A-axis and/or B-axis. For example, pivoting or rotation of the second rotary table 170 about the A-axis may pivot or rotate the stock block 30 toward or away from the cutting tool 20, thereby removing material from the stock block 30. In an embodiment, the A-axis may be approximately parallel to the X-axis. Moreover, in some examples, the A-axis may be offset from the X-axis.

In addition, as mentioned above, in some embodiments, the stock block 30 may be pivoted or rotate about the B-axis. The B-axis may be approximately parallel to the Z-axis. Moreover, in some instances, the Z-axis and the B-axis may collinear, such that the B-axis and the Z-Axis lie along the same imaginary line. Alternatively or additionally, the Z-axis and the B-axis may be parallel to and offset from each other.

Generally, the multi-axis machining system 100 may move the cutting tool 20 and/or the stock block 30 along or about any of the X-axis, Y-axis, Z-axis, A-axis, B-axis, or combinations thereof independently and/or synchronously or simultaneously. In some embodiments, such movement may be produced by the multi-axis machining system 100 while the cutting tool 20 rotates and engages the stock block 30, thereby removing material therefrom. In some instances, the cutting tool 20 may have no rotation and may be advanced toward and/or into the stock block 30, while the stock block 30 rotates (e.g., the cutting tool 20 may be a boring bar that engages the stock block 30 as the stock block 30 rotates about the B-axis). In any event, relative movement between the cutting tool 20 (while rotating the cutting tool 20 or maintaining the cutting tool 20 rotationally fixed) and the stock block 30 may machine a suitable or desired shape and/or contour in or on the stock block 30.

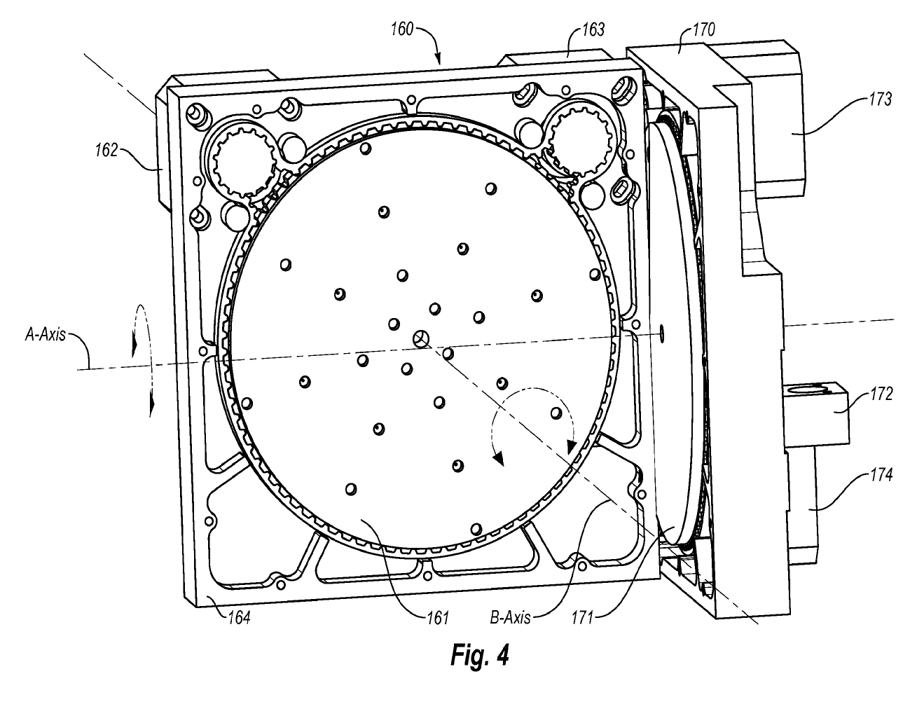

As mentioned above, the first rotary table 160 may rotate the stock block 30 about the B-axis. As shown in FIG. 4, in an embodiment, the first rotary table 160 includes two stepper or servo motors 162 and 163. In particular, the stepper motors 162 and 163 are operably connected to the work surface 161 in a manner that rotation of the stepper motors 162 and 163 produces a corresponding rotation of the first rotary table 160 (e.g., the first rotary table 160 may have gear teeth engaged with a belt that is connected to and driven by the stepper motors 162, 163). A controller may provide a signal to activate and control rotation of the stepper motors 162 and 163. For instance, the controller may receive a signal from an encoder, which may include information related to angular displacement of the first rotary table 160. Hence, a control loop may be established to produce a suitable or desired speed, direction of rotation, angle of rotation, or combinations thereof for the first rotary table 160 about the B-axis of the multi-axis machining system. In some embodiments, the encoder may be coaxially located with the B-axis. It should be also appreciated that the work surface 161 may be rotated by gears, worm screws, etc., connected to one or more stepper or servo motors and engaged with a corresponding gear connected to the work surface 161.

Similarly, the second rotary table 170 may include a stepper or stepper motor 173 and an encoder 174. The stepper motor 173 may rotate the mounting surface 171 about the A-axis. Also, the controller may control rotation of the mounting surface 171 in the same or similar manner as the rotation of the work surface 161. Moreover, in some instances, the first rotary table 160 and the second rotary table 170 are connected together such that the A-axis and B-axis lie or may be aligned to lie in the same plane (e.g., in a horizontal plane). Additionally, rotating the mounting surface 171 together with the first rotary table 160 may reposition or reorient the B-axis, such that the B-axis and the A-axis define a plane that forms a non-parallel and/or non-perpendicular angle with the horizontal plane (e.g., with the support surface).

As described above, in at least one embodiment, the nut 172 connects the second rotary table 170 to a lead screw, which may advance the second rotary table 170 and the first rotary table 160 along the Y-axis. Also, in one example, the first rotary table 160 includes a housing 164 that at least partially encloses the work surface 161. Furthermore, in an embodiment, the housing 164 connects or may be secured to the mounting surface 171 of the second rotary table 170. It should be appreciated that, generally, the housing 164 may have any suitable shape and/or size (e.g., the housing 164 may be approximately rectangular and/or may have approximately flat or planar sides). For instance, planar or flat sides of the housing 164 may position and/or orient the housing 164 relative to the mounting surface 171.

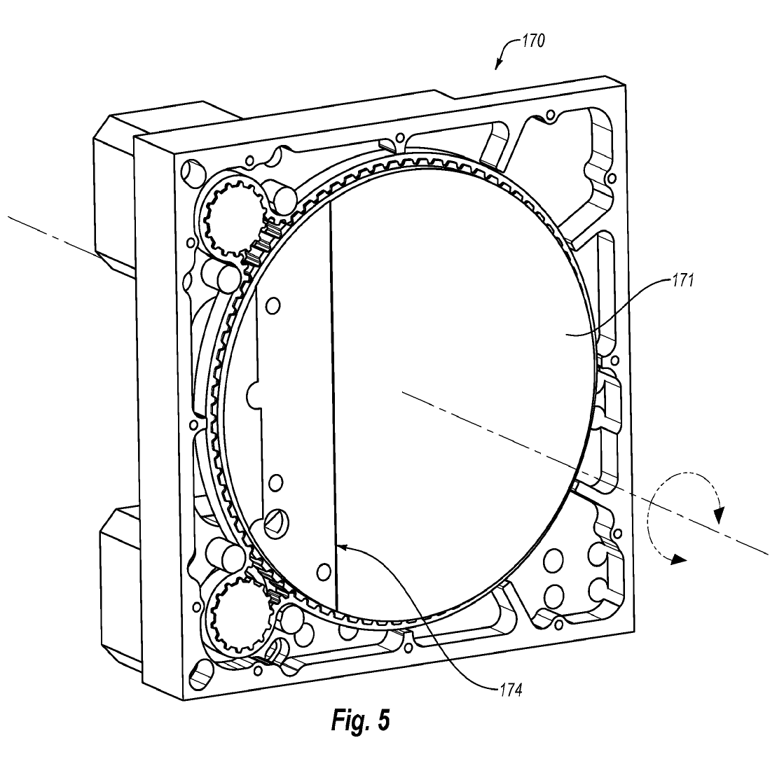

According to at least one embodiment, as shown in FIG. 5, the mounting surface 171 may include a location slot 174, which may position and/or orient the housing 164 and the first rotary table 160 (FIG. 4) relative to the mounting surface 171 and to the A-axis. Likewise, positioning and orienting the housing 164 and the first rotary table 160 (FIG. 4) on the mounting surface 171, positions and orients the B-axis relative to A-axis. More specifically, the slot 174 may have width that is similar to the width of the housing 164 (FIG. 4). For instance, the slot 174 may be slightly wider (e.g., by 0.0001″, 0.0005″, 0.001″, 0.005″, 0.010″) than the width of the housing 164 (FIG. 4).

In some embodiments, the mounting surface 171 may include multiple openings or holes at or near the location slot 174; one or more bolts may pass through the holes in the mounting surface 171 and fasten the housing 164 of the first rotary table 160 (FIG. 4) to the mounting surface 171. As such, the first rotary table 160 (FIG. 4) may be removably secured or fastened to the mounting surface 171 of the second rotary table 170. In alternative or additional embodiments, the first rotary table 160 may be permanently attached to or integrated with the mounting surface 171 (e.g., the housing 164 of the first rotary table 160 may be welded to the mounting surface 171).

It should be appreciated that any number of additional or alternative suitable mechanisms may secure the first rotary table to the mounting surface 171 of the second rotary table 170. For instance, one or more dowel, interlocks, or other features may provide suitable alignment and/or positioning between the mounting surface 171 and the first rotary table 160. Furthermore, clamps, straps, snap-in features, etc., may secure the first rotary table 160 to the mounting surface 171.

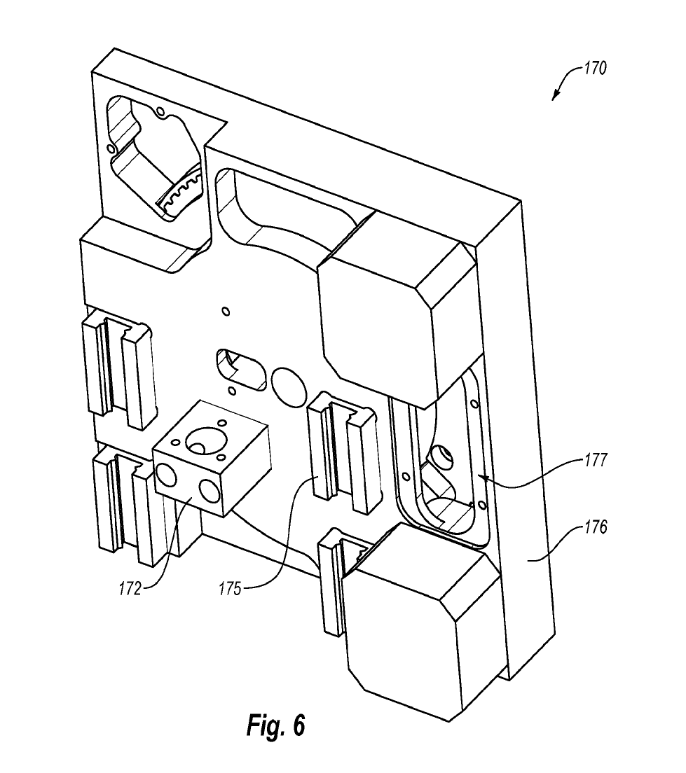

As shown in FIG. 6, in some embodiments, the second rotary table 170 includes the nut 172 that may be engaged with the lead screw in the vertical support. In some embodiments, the nut 172 may be secured to a housing 176 of the second rotary table (e.g., the nut 172 may be bolted to the housing 176). Alternatively, the nut 172 may be integrated with the housing 176 of the second rotary table 170.

Furthermore, in at least one embodiment, the second rotary table 170 includes pillow blocks 175 that may slidably secure the second rotary table 170 to the guide rails attached to the vertical support. Moreover, the pillow blocks 175 may prevent the second rotary table 170 from moving along the directions of X-axis and/or Y-axis of the multi-axis machining system 100. For instance, the second rotary table 170 may include to pillow blocks 175 for each guide rail. It should be appreciated, however, that the second rotary table 170 may include any suitable number of pillow blocks, which may have any suitable shape and/or configuration and may be slidably engaged and/or may be secured to a corresponding guide rails.

Generally, the pillow blocks 175 may be attached to the housing 176 of the second rotary table 170. In some embodiments, one or more screws or bolts secure the pillow blocks 175 to the housing 176. Furthermore, in at least one embodiment, the housing 176 includes pockets for locating and/or orienting the pillow blocks 175 (e.g., two pillow blocks associated with the same guide rail may be oriented and positioned in alignment with each other on the housing 176). Alternatively, one, some, or all of the pillow blocks may be integrated with the housing 176.

In an embodiment, the second rotary table 170 may include one or more wire channels or cutouts that may facilitate channeling or routing one or more wires or cable from the stepper motors of the second rotary table 170 to a controller. For instance, the housing 176 may include a wire cutout 177. It should be also appreciated that the first rotary table 160 (FIG. 4) may include one or more wire channel and/or cutouts, which may be the same as or similar to the wire cutout 177 of the second rotary table 170.

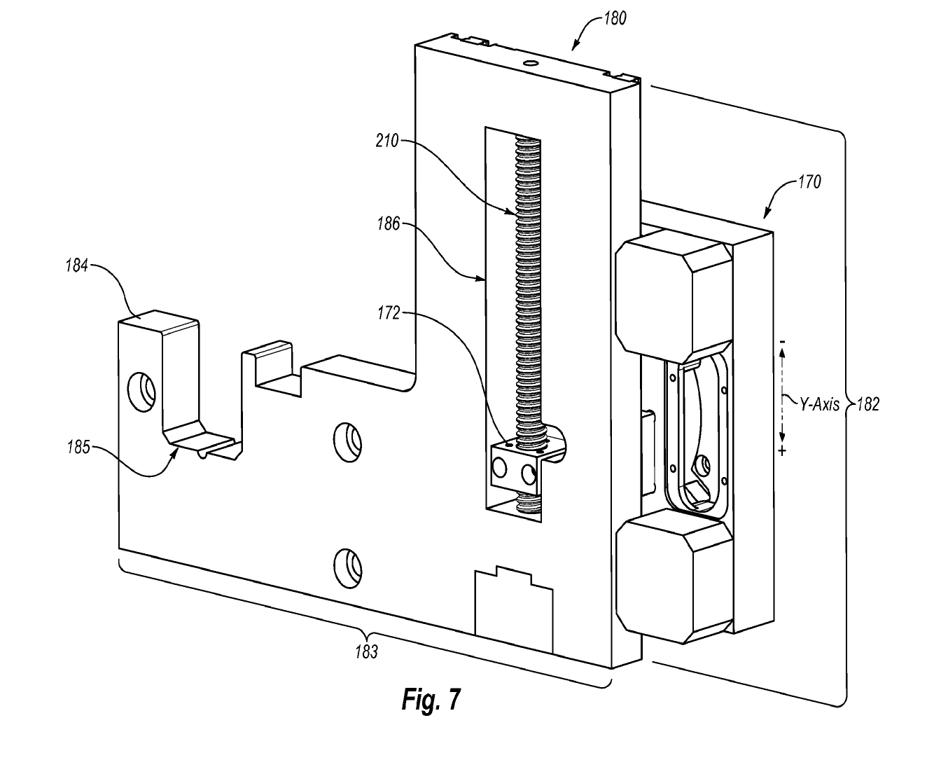

As described above and as shown in FIG. 7, the lead screw engaged with the nut 172 may control location and or movement of the second rotary table 170 along the Y-axis of the multi-axis machining system 100. More specifically, while stationary (i.e., not rotating), the lead screw 210 may support the second rotary table 170 (and the first rotary table 160 (FIG. 4)) at a suitable or predetermined fixed position along the Y-axis of the multi-axis machining system 100. Rotation of the lead screw 210 may advance the second rotary table 170 (and the first rotary table 160 (FIG. 4)) along the Y-axis in the positive or in the negative direction.

In an embodiment, the vertical support 180 rotatably secures the lead screw 210 in an opening 186. For example, the nut 172 may fit into the opening 181 and engage the lead screw 210, such that rotation of the lead screw 210 produces linear movement of the nut 172 and the second rotary table 170 along the Y-axis, as described above. In particular, for instance, clockwise rotation of a right-handed lead screw 210 may advance the second rotary table 170 in the negative direction, and counterclockwise rotation may advance the second rotary table 170 in the positive direction along the Y-axis.

Moreover, as mentioned above, the vertical support 180 may be generally L-shaped. In some examples, a vertical portion 182 of the L-shaped vertical support 180 extends vertically and a horizontal portion 183 of the vertical support 180 extends horizontally. In some instances, a top surface 184 of the horizontal portion 183 may be approximately coplanar with a top surface of the machine base 110. Also, in some embodiments, the vertical support 180 includes a cutout 185 that may facilitate the X-axis stepper motor, which may extend through therethrough.

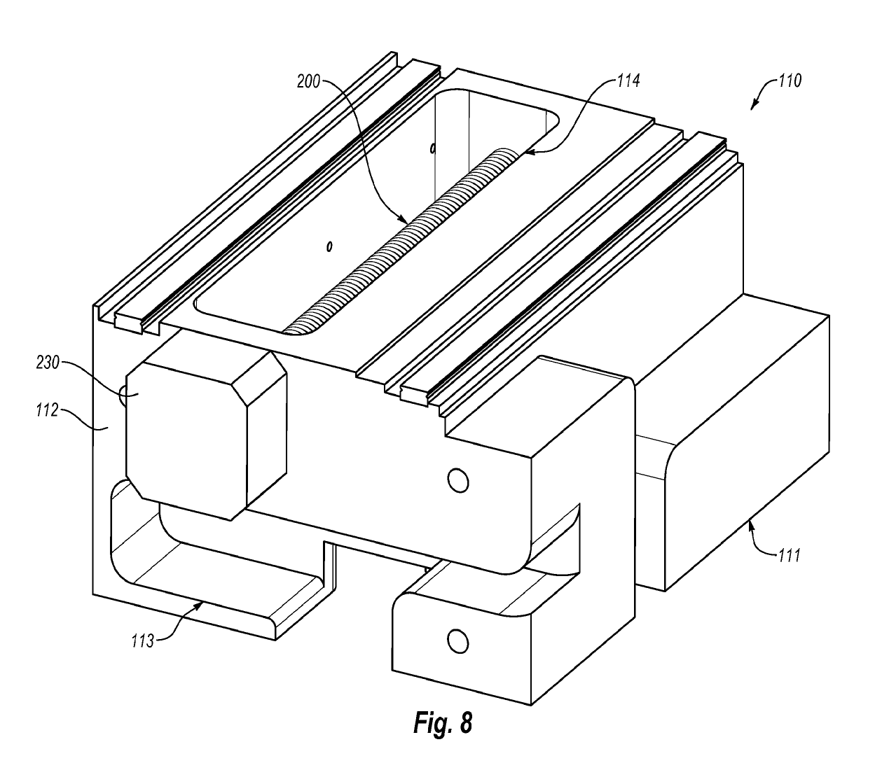

In some embodiments, as shown in FIG. 8, the vertical support is mounted to or integrated with a side surface 112 of the machine base 110. As mentioned above, the vertical support may be bolted to the machine base 110. Also as described above, in at least one embodiment, the machine base 110 includes the platform surface 111 that may be placed on the support surface supporting the multi-axis machining system. In addition, according to one or more embodiments, the platform surface 111 may be approximately coplanar with a bottom surface of the vertical support, which may provide additional support and/or stability to the multi-axis machining system, when positioned on the support surface.

Moreover, in some examples, the machine base 110 includes a wire slot 113 that may facilitate storing and/or channeling wires from one or more stepper motors to the controller. The machine base 110 also may include a cavity 114 that may house the lead screw 200 that may be operably connected to the X-axis stepper motor 230 and to the nut of the carriage 120. Additionally or alternatively, the machine base 110 may include any number of suitable slots, cutouts, channels, similar features, or combinations thereof, which may facilitate cables, wires, or other elements or components passing therethrough, as may be suitable for a particular embodiment.

While the foregoing is directed to embodiments of the present invention, other and further embodiments of the invention may be devised without departing from the basic scope thereof, and the scope thereof is determined by the claims that follow.

While various aspects and embodiments have been disclosed herein, other aspects and embodiments are contemplated. The various aspects and embodiments disclosed herein are for purposes of illustration and are not intended to be limiting.

What is claimed is:

1. A multi-axis machining system comprising:
a first rotary table including a work surface rotatable about an B-axis relative to an approximately horizontal support surface;
a second rotary table including a mounting surface rotatable about a A-axis relative to the horizontal support surface, the second rotary table being linearly moveable along a Y-axis that is approximately perpendicular to the horizontal support surface, the first rotary table being secured to the mounting surface of the second rotary table;
a spindle head securing a spindle, the spindle head being linearly moveable along a Z-axis relative to the horizontal support surface and toward and away from the work surface of the first rotary table, the Z-axis being approximately perpendicular to the Y axis and approximately parallel to the horizontal surface.

2. The multi-axis machining system of claim 1 further comprising a carriage linearly movable along an X-axis relative to the horizontal support surface, the X-axis being approximately perpendicular to the Y-axis and to the Z-axis and approximately parallel to the horizontal support surface, the spindle head being movably connected to the carriage.

3. The multi-axis machining system of claim 2 further comprising a screw operably connected to the second rotary table in a manner that rotation of the screw produces linear movement of the second rotary table along the Y-axis.

4. The multi-axis machining system of claim 3 further comprising one or more of a servo motor or a step motor operably connected to the screw in a manner that rotation thereof produces a corresponding rotation of the screw.

5. The multi-axis machining system of claim 2 further comprising Z-axis ways movably connecting the spindle head to the carriage.

6. The multi-axis machining system of claim 2 further comprising a machine base, the carriage being moveably connected to the machine base.

7. The multi-axis machining system of claim 6 further comprising a vertical support attached to or integrated with the machine base, the second rotary table being movably connected to the vertical support.

8. The multi-axis machining system of claim 7 wherein the vertical support is generally L-shaped.

9. The multi-axis machining system of claim 7 wherein the machine base includes a support platform positioned on the horizontal support surface, and the vertical support includes a bottom surface positioned on the horizontal support surface.

10. The multi-axis machining system of claim 7 further comprising Y-axis ways moveably connecting the second rotary table to the vertical support.

11. The multi-axis machining system of claim 1 further comprising a spindle motor operably connected to the spindle.

12. The multi-axis machining system of claim 1 further comprising a cutting tool secured in the spindle.

13. The multi-axis machining system of claim 12 wherein the spindle includes quick tool release.

14. A multi-axis machining system comprising:
a machine base positionable on an approximately horizontal support surface;
a carriage movably connected to the machine base and linearly movably relative to the machine base along an X-axis;
a spindle head movably connected to the carriage and linearly moveable relative to the carriage along a Z-axis that is approximately perpendicular to the X-axis, the X-axis and the Z-axis defining an imaginary plane that is approximately parallel to the horizontal support surface;
a first rotary table including a mounting surface rotatable about an A-axis relative to the horizontal support surface, the A-axis being approximately parallel to the X-axis, the second rotary table being linearly moveable along a Y-axis that is approximately perpendicular to the horizontal surface; and
a second rotary table secured to the mounting surface of the first rotary table and including a work surface rotatable relative to the horizontal support surface about a B-axis.

15. The multi-axis machining system of claim 14 further comprising a vertical support attached to or incorporated with the machine base.

16. The multi-axis machining system of claim 15 further comprising one or more ways movably connecting the first rotary table to the vertical support.

17. The multi-axis machining system of claim 14 wherein the machine base includes a platform surface configured to orient the machine base on the horizontal support surface.

18. The multi-axis machining system of claim 14 further comprising a spindle mounted to the spindle head and a spindle motor operably connected to the spindle in a manner that rotation of the spindle motor produces a corresponding rotation of a rotatable portion of the spindle.

19. The multi-axis machining system of claim 18 further comprising a cutting tool secured in the rotatable portion of the spindle.

20. A method of machining a stock block, the method comprising:
moving the stock block along a Y-axis that is approximately perpendicular to a horizontal plane;
pivoting the stock block about an A-axis and a B-axis, the B-axis pivoting about the A-axis, and the A-axis being approximately parallel to the horizontal plane;
linearly advancing a rotating cutting tool along an X-axis that is approximately perpendicular to the Y-axis, approximately perpendicular to a rotation axis of the cutting tool, and approximately parallel to the horizontal plane;
linearly advancing the cutting tool along a Z-axis that is approximately perpendicular to the X-axis and Y-axis and approximately parallel to the rotation axis of the cutting tool and to the horizontal plane.
